(19) United States
(12) Patent Application Publication
(10) Pub. No.: US 2010/0313869 A1
(43) Pub. Date: Dec. 16, 2010

(54) Catalytic reactor hetero-structure and applications

(76) Inventors: Claudiu Iulian Muntele, Huntsville, AL (US); Liviu Popa-Simil, Los Alamos, NM (US)

Correspondence Address: Liviu Popa-Simil, 3213-C Walnut St., Los Alamos, NM, 87544-2092, US

(21) Appl. No.: 12/287,528

(22) Filed: Oct. 11, 2008

Related U.S. Application Data
(60) Provisional application No. 60/998,721, filed on Oct. 12, 2007.

(51) Int. Cl. A41D 13/005; B01J 19/00; G05D 23/01; B01D 53/86

(52) U.S. Cl. 126/208; 422/108; 422/109; 423/210

(57) ABSTRACT

The micro-flow hetero catalytic structure is developed in a complex catalytic reaction system electronically controlled that can handle simultaneously many reactants in the proper operation domain. A distributed electronic processing system based on anticipated parameters and controls the entire system optimal regime. The method of obtaining the optimal response from the catalysts is that of maintaining the thermodynamic operation parameters at right values by a set of heat exchangers, fans, valves and actuators in closed loops and processor control having the safety embedded. The applications are covering chemical synthesis, heating, air and gas cleaning, fuels and alcohol reforming.

### CROSS REFERENCE TO RELATED APPLICATIONS

This application claims the benefit of U.S. Provisional Application No. 60/998,721, filled on Oct. 12, 2007, which is hereby incorporated by reference in this entity.

### BACKGROUND

Many catalytic reactors do not achieve the optimal performances (see Annex 1—State of the art) due to the complexity of the reaction process and the fact that most of the catalysts operates in a narrow domain that have to be properly stabilized.

The new development of a micro hetero reactor structure comes to make an overall mitigation of the mass and heat flow, in a transitory mode using stimulated fluctuations to produce homogenization and increase reaction probability. There are also many applications developed encountering many issues in their pursue for perfection, as life time, clogging, catalyst burnout and pollution, mechanical stability, toxic by products, etc.

The present solution of a reactor assembly improves most of the parameters by specific combinations and has a large range of applications from simply clean safe heating to reactant oxidation, gas cleaning and biologic sterilization.

### SUMMARY

A catalytic structure assembly based on micro-fluidics controllers to solve the mass flow compatibility, using controlled gradient heterogeneous flow distribution in catalyst bed and its accessories to control stoichiometry, heat flow and temperature distributions.

The system comprises a plurality of specialized modules that manipulates all the processes in the system from input to output and services, being driven by a plurality of interconnected controllers.

This reactor structure is further applied in various assemblies belonging to a broad spectrum of applications customized to maximize the performances and safety and minimize the costs.

### BRIEF DESCRIPTION OF THE DRAWINGS

FIG. 1. Main embodiment of the invention meant to assure the modular structure of the catalyst system

FIG. 2A. Personal Mobile Heater for food, drinks, hands and suits.

FIG. 2B. Human heater deodorizer is composed from a personal heater coupled to an internal air circulation deodorization device

FIG. 3A. Box heater—in the Hydrogen producing device or other fueling device

FIG. 3B. Individual unit heater—hot plate

FIG. 4. plurality of catalytic heating plate

FIG. 5. Catalytic air cleaner for auto-vehicles odor and toxins removal system to habitable space oxygen level control.

FIG. 6. Toilet and technologic rooms exhaust cleanup application

FIG. 7. Heating device for medical transfusion liquids heating.

FIG. 8 Warm clothing and air heated blankets for medical emergencies

FIG. 9. Medical application for emergency operator tent heating with sterilized air in white-room regime

FIG. 10 IR-UV sterilization base on low flammability system.

FIG. 11 Hydrogen based devices leakage recovery.

### DETAILED DESCRIPTION

The development of a complex, multi catalyst system to properly accommodate a plurality of reactants with its appropriate catalyst and parameters to assure a near-perfect reaction control, with minimal negative impact on environment made possible the usage of the same design after customization on a large variety of applications.

A particular case of the catalytic reactor system usage as heater with a plurality of combustibles is creating an interesting development in heating devices for food, tourism, housing, medical interventions, anti-explosive housing thermal assistance emergency and military.

Most of the catalytic burners have a good behavior with Hydrogen Oxygen reactants while with the rest of fuels and oxidizers the thermal range for a good operation is reduced.

The following supplementary applications are presented as examples of catalytic reactors usage:

Heaters:

Public Use:
Personal mobile heater—food, drinks, hands and suit
Coat heater is composed from a personal heater coupled to an internal air circulation deodorization device
Box heater—in the Hydrogen MRE device
   Autonomous device
Food picnic heater is a converted box heater operating in regime of barbeque device as IR oven or thermostat for food.

Medical Use:
blood IV heating,
blanket heating,
emergency tent heating,
IR sterilization base on low flammability system

Military and Emergency Use:
Vest heater for harsh climate with reduced IR and odor signature
Tent—shelter heater
Vehicle start-up or ambient heater in cold climate
Absorption silent heater-cooler system
Thermo-electric power generator
Liquids distillation
Food heating with Hydrogen recovery

Air Decontamination Cleaning and Conditioning
Auto vehicle odor and toxins removal system to habitable space oxygen level control.
Personal air purifier/deodorizer
Shelter/tent air cleaner deodorizer
Medical operation room air sterilization

Industrial Use:

Mine/Ex environments air decontamination cleaning and conditioning

Hydrogen based devices leakage recovery.

Smelter gases purification,

Nuclear reactor tritium removal from air leakage

Green houses CO₂ enrichment

Methanol reforming, hydrogenation

Extreme Confined Environments, Space, Underwater, Underground
Air decontamination, CO₂ removal, cleaning and conditioning

The invention corrects the problem encountered by most of the catalysts at startup and shutdown when toxic products are released, and even improves the steady state regime operation by continuous parametric control.

The system according to the invention has the capability to produce a power or reactant flow variation by a special strategy applied to assure a perfect reaction all the time based on:
Electrical thermal assistance
Catalytically shutdowns assisted by exhaust catalytic burners that complete the burning.
Catalyst changing device in exhaust
Modular start-up
Multi-fuel startup/shut-down
Catalyst cleanup and event preparation
operation in constant temperature and temperature—flow control assisted system

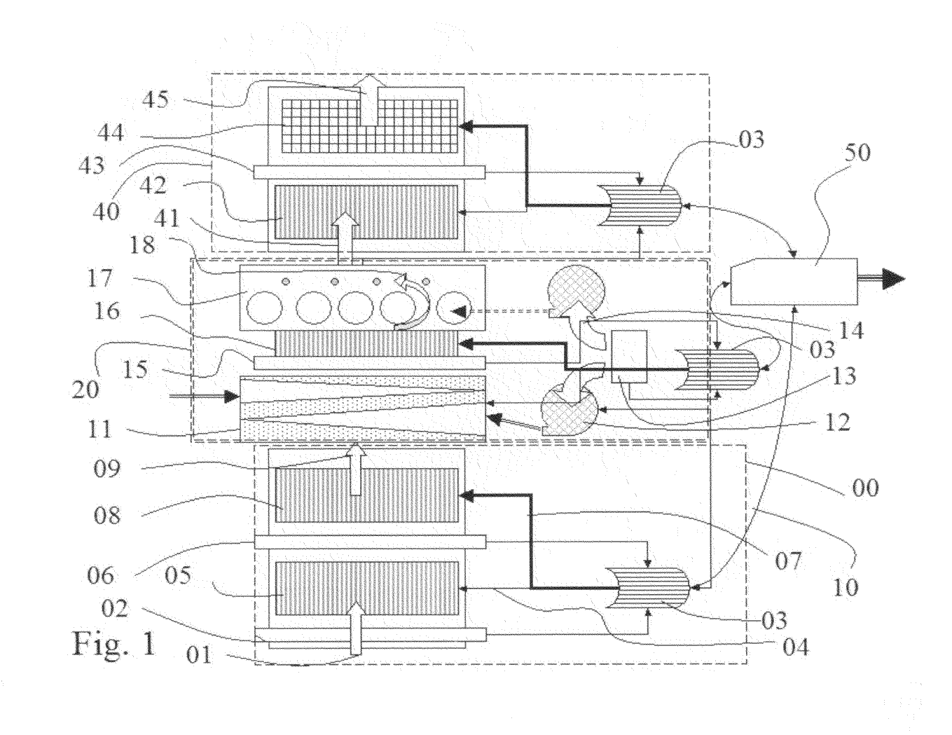

FIG. 1 shows a main embodiment of the invention meant to assure the correct operation of a catalyst system making the perfect parametric matching.

The structure comprises a plurality of functional blocks:
Main effluent entry processing 00
Catalytic reactor unit 20
Exhaust of the reacted effluents 40
Process control unit 50

The main effluent entry system 00 system takes one or a plurality of effluents 01 that flow through the assigned initial measurement unit 02 that measure all the significant process parameters and is communicating to the specific processor 03.

The processors react to the parameters by introducing corrections 04 in the actuating units 05. The amplitude of this initial correction is meant to make a coarse adjustment of the effluent parameters in the range of 80-90% of the required adjustment based on previous information updated by the measured values 02. The timing and flow is important because the adjustments have to appear at the right time and place.

The effectiveness of the adjustment is measured by at least one parametric measuring unit 06 that is reintroducing the data in the processor and generates a new timed correction 07 using the corrective unit 08 meant to provide the effluent 109 the right entry values in the first stage of the catalytic reactor 11. The control unit also uploads the measurement history in a process-supervising unit 50 that may send back corrections 10.

The reactor structure 20 has a perpendicular flow access in the reaction area 11 based on a positive pressure system 12. A plurality of reactive effluents may be added using the pressure—flow adjustment system 12, that takes the effluent through a parametric measurement unit 03 in order to make the right predictions for the required changes and adjustments to be applied in order to make it compatible with the fuel's performances. A plurality of reactors with various catalysts may be stacked together forming various series and parallel effluent flow circuits.

The most common adjustments are the pressure, temperature and flow to keep the catalyst in the initial stage in the desired operating regime. Then it has to be considered the energetic output of the reaction induced and the fact that this modifies the catalyst 11 properties demanding a new pressure—temperature regime. This adjustment is made under the process automation system 03 by using the parametric corrector system 15-16.

The parametric control system 15 is a reaction product output parametric measurement system, acting in parallel with the predictive calculator and taking the abetment values as corrective process parameters, while the module 16 is a dynamic parameter modification that in the simplest case may be a heat-exchanger as heat sink or heat-pipe. In the most cases after the catalytic reaction heat is released that drives to catalyst warm-up taking it out of good operating regime making it generate a plurality of unwanted secondary products. The parametric rectifier unit 16 prevents this out-of-range behavior. As the stage to catalytic reaction is a gradual approach, producing by a unit the coarse reaction and by the second stage 17 we add the fine reaction tuning in order to make the output flow 18 compatible with the process quality requirements.

After the catalytic reaction has been successfully finalized the resultant flow is passing into the final processing unit 40 before delivery or exhaust. It has to be noted that a plurality of catalytic stages may be used in order to treat complex gases as smelter or tail gases each catalyst and flows parameters fine tuned to get the best reaction output and maximize the life time.

The final stage 40 has similar functions as the primary stage to measure and adjust the parameters of the output flow 41.

The system 42 is correcting the flow 41 parameters under a similar input control unit 03 using an adjustment measurement stage 43. The measurement stage 43 also assures the quality of the process, as the resulted flow 45 is passing through a final parametric adjustment 44 and delivered or exhausted.

A higher rank processor unit 50 that assures the upper level communication and overall process coordination and quality controls the entire process. The whole system philosophy starts from the observation as there is no catalyst tolerant to a wide range of effluents parameters and for a process of quality the right parametric matching is required. For the transitory regimes as start-up, stop, and flow content modifications complex maneuvers like reverse heat-flow, electric warming, multiple adjustment reactants are performed using actuators under controllers control as part of the process optimal customization and programming.

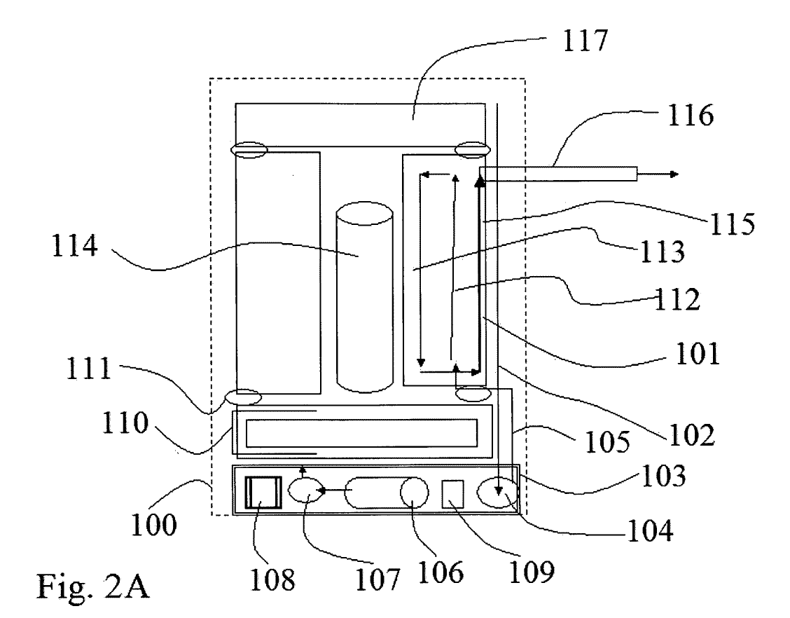

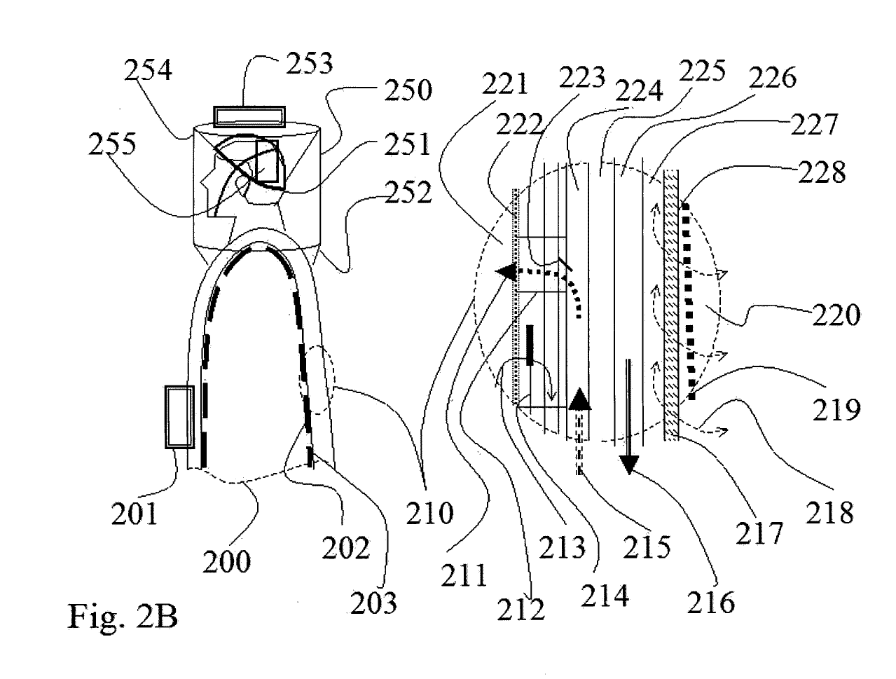

FIG. 2A Shows another main embodiment of the present invention the personal mobile heater 100 for food, drinks, hands and suit an application to the system in FIG. 1. The reaction is exothermic also called oxidation and when the reactants are cold fuels, the reaction holds the common name of burning. There are several combinations of catalysts and fuels that can be used together or separately with the aim of maximizing the ratio performances over cost, classical Platinum coated Alumina being too expensive for mass usage in such devices.

The device 101 works identically with a hot plate with adjustable temperature, having the fluid circuit completely separated from the heating circuit. The system have to be position insensitive or in the second version with a predefined-locked operation position. As a feature of the main system that has controlled flows the position insensitivity is assured.

There is a plurality o fuels it may work as function of requirements and availability, and a large variety of catalysts and processes to produce them. The most preferred fuels are in order Hydrogen, Methanol, Acetylene, Ethanol, Methane, Ethane, Propane gas, Butane, gasoline, etc each requiring its catalyst-temperature—pressure combination. There is no cheap universal combination, but this exists, being mainly based on noble rare materials, the control system being able to easily handle multi-fuels.

The temperature range is from 0 C up to 100 C inside depending on application such as: 3-10 C for antifreeze, 20-30 C for drinkable-eatable foods maintenance in the cold climate, 30-40 C for hands heating and mild food heating, 40-65 C for food heating, and hot drinks, 70-100 for food, water boiling, while over 100 and lower than 200 for backing and cooking. The power level depends on the insulation figure and external surface and leaks. Because the power range is varying from several Watt in antifreeze regime up to 1 KW in cooking regime, the individual traveler's pack will have in composition at least 3 catalytic heating devices, and a plurality of fuels, controlled by a micro-processor operation system.

The user using a minimized dialogue box is selecting the regime while it sets the desired position of the adjustable heat box that may provide heat inside or on some of the walls. In its operating position is a variable volume rectangle, with modular inflatable walls. The walls have variable shape due to an elastic pliable structure, containing the heating plate.

There are pluralities of fuels this system may operate. For temperatures above freezing the hydrogen solid generators as Mg, Fe water may be used. Solid carbide and water may be used for acetylene on spot production as for under freeze temperatures. Liquid methanol, ethanol, benzene, benzenes may also be used as well as compressed and liquefied gases with the restriction as their temperature have to be assisted too.

Another requirement of the application is that to be anti-explosive cased, and to have a perfect burning with clean exhaust separated from the inner air and driven at a certain distance by a tube. Using a non-reflective, non-emissive surface materials and a cold external wall, by making the burners air intake all around the external surface made by a porous fabric, may minimize the IR signature.

The heating unit 100 is made from flat hot plates 101 and insulator expandable plates 110 up to six or more being combined such as to fulfill the usage desires, from heating hands to barbeque/fry. The air intake 102 is made on periphery and aspirated in a fan 104 inside the utility pack 103. The air exhaust 105 is driven towards the center of the catalytic hot plate 112 surrounding the fuel and reacting down to complete burning. The heat generated is transmitted by IR radiation, conduction and convection towards the center of the plate to a hard-coated aluminum surface 113 facing the center of the box.

The cooled burned gas is then passing the exterior surface giving the remnant heat to intake air via a heat exchanger 115 and is evacuated through a duct 116. The negative pressure on the borders makes that the box to be odorless and the potential gas leakage to be reabsorbed without contact to the inner surface.

The sealing hinges 111 increase the insulation of the central box cavity. Inside the utility box 103 there are a plurality of fuel tanks 106 driving to specialized fuel pumps 107 or manual pressurizing system and through a distribution system under the control of the processor 108 is assuring the heaters optimal operation regime.

An electric system 109 formed from an electricity harvesting system, battery is powering the controller and actuators. The power variation is made by switching the number of catalytic cell in operation and by smooth continuous variation inside the catalyst operation domain.

The lid 117 may hold multiple functions from sealing the box, to secondary deposit for accessories. The box content 114 requirements determines the operation regime selected on process control system 108.

FIG. 2B shows another embodiment of the invention as a complex application in human heater deodorizer comprising a personal heater functioning also in odor burning regime coupled to an internal air circulation structure embedded in coat and protective equipment for face hands and legs, separating the exterior space from the body space with minimal thermal and chemical signature.

The development of this new embodiment was generated by the need to give the proper answer to the question: When body needs external auxiliary heating and the normal coat or cloth is not good enough.

Usually normal coating is not good in variable effort regime as military, alpinists, cave exploration or cold climate requiring continuous variation of the insulation figure to assure the proper heat flow.

The human muscular activity is also accompanied by a high release of odor sweat and breathed air that proved a valuable tracking device and a large IR signature. A complete active suit may minimize all together, while providing the bearer with fresh clean, sanitized air.

The second question to be answered was: What are the most appropriate temperature distribution making the human body most healthy and comfortable in agreement with its operating conditions?

The answer to this question is not simple because there is no unique solution and more the body temperature distribution depends on the effort and metabolic stage—digestion, sleep, high effort, being differing by individual therefore requires customization. In relation with environment that requires both cooling and heating.

A body level micro=processor is designed to identify the regimes by measuring the breathing flow, heart rate, temperatures movement regime and preset the best acceptable operation temperature—its control being different from the action of blind feedback systems that control a temperature by adjusting the heat flow. This kind of feedback may be dangerous for the body health.

Due to an intelligent control the suit becomes for the body its first confinement-adjustment chamber, while the presence of the human body signature in the environment is drastically minimized. The extra heat released may be driven in the right places with minimal visibility, being possible that the single exhaust to be oxygen depleted air while water and CO₂ being stored.

Reduced contamination, anti-chemical, anti-bacteriologic suit having in configuration a comfort function regarding the optimal body temperature field distribution. Bullet, fire, chemical proof, active chromatic signature minimization coatings may be added and morphed in the system.

The protective suit, vest, coat 200 has a multi-layer air circulating system operated by a processor unit located in the technologic unit 201.

The technologic unit is customized as function of the function it has to accomplish as supplementary body cooling-heating, deodorization, anti-chemical and bacteriologic protection, and minimized heat signature. It is based on a catalytic HEPA filter and a set of absorption filters for plume signature reduction. Usually a human plume is made from an exhaust of water vapors, carbon dioxide and another large spectrum volatile organic compounds (VOC). The technical equipment usually detects IR and carbon dioxide pulsed plume to identify life presence while the predator insects and animals usually detect the VOC to positively identify the target.

During various activities the body worms up non-uniformly and sweats, respiration and overcools in different locations. To balance the effect of confinement clothes there is needed to apply a moderate correction to free air body, at optimal ambient temperature—gym-room condition. These conditions are correlated with the effort level and body parameters by the processor unit.

The Suit has tiles for temperature regulation 202 separated by areas of high material insulator 203 having a role in body parameters maintenance and odor absorption. A section in the suit structure 210 is presented in zoom area in the right of the picture.

The conditioning air flow 211 is introduced from the alternate hot-cold tubes using the MEMS valves 223 that makes the right temperature combination in the space bordered by separators 212. The local odors are collected in the aspiration tube 213, and carried to the deodorization catalytic device. The temperature is measured by a set of sensors embedded in each tile of structure. The conditioned air 214 is circulating through set of interlaced tubes 224 carrying hot and cold air. The gas for the catalytic burner is taken from a set of outer tubes 226 carrying the inner gas and preventing any direct communication between the inner and outer side.

The external layer 228 is a hydrophobic layer inert to IR emission/reflection having the main role of making no signature in environment 220 and preventing water to pass inside. Depending on the state of outer space 220 contaminations with chemical or bacteriologic agents the channels 227 may be used to adjust the outer temperature for IR pattern minimization and to blow clean air to create a pellicle cushion to keep the pollutant away from the suit. In this case the unit 201, aspirates the air decontaminates and pushes into the circuits. The layer 217 is operating like a thermal insulator having a conductive mesh to prevent EM field influencing the person or reflecting on conferring the bearer the stealth and pulsed power shielding capabilities. The inner space 221 may be the bearer skin or lingerie in contact through the layer 222 that is a hairy hydro-neutral layer or hydrophilic to allow the water being absorbed and transmitted in the conditioning system. An alternate of materials as neoprene or gore-tek are recommended to separate the layers and minimize the power.

For environments where the human trace have to be minimized or for contaminated environments a head protection-insulation 250 may be wear. It relies on module 253 to catalytically burn the odors from inside to outside and the pollutants from outside to inside separating the human from the environment it steps in. The device is elastically connected to the suit by a light bellow. The entire structure is rigid on head by the belt 251, 254. The hearing and visualization is improved by the devices 255 placed aside with direct on-eye projection as IR, THz, Radar/Sonar, sound/EM goniometry stereoscopic imaging. The head may have all the features of the body suit.

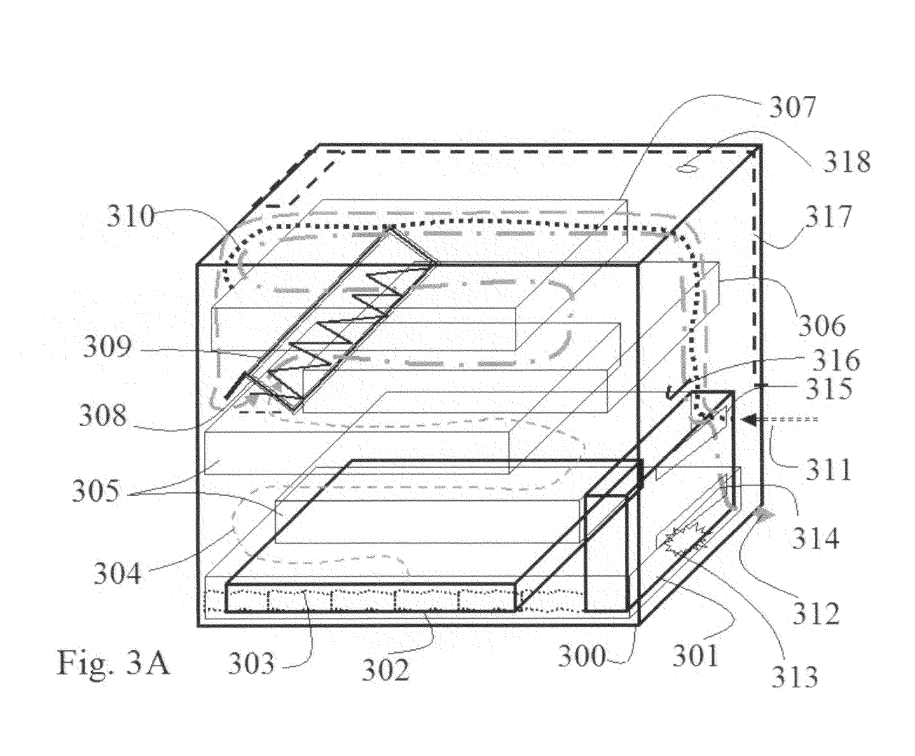

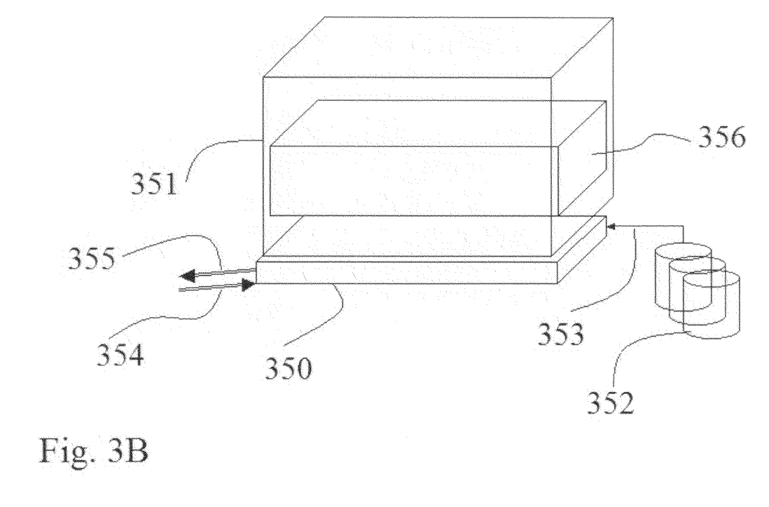

FIG. 3A-Box heater—in the Hydrogen producing device or other fueling device made with distributed heat sources for uniform safe power application.

An example of hydrogen producing device is the actual meals ready to eat (MRE) metal powder sachets. These MREs are using a bag of about ½ Kg or more of Mg, Fe, etc. powder flooded with water and during oxidation releasing Hydrogen, water vapors and heat. Its usage in cold areas releases a plume rising above the eating-place that becomes very embarrassing for special applications, where the fingerprint in environment should be minimized.

The usage of an ordinary catalyst barrier (Pt, Pd based) may lead to the reduction of the actual (year 2006) box content from 4 Oxidizing material to 1 on the bottom with reshaping the content makes the plume disappear and the released hydrogen to be further oxidized to water that drops the heat on the upper food.

The cardboard box 300 containing the meals in parallelepiped trays placed interlaced in the box using a set of cardboard supports having the role to guide the gas flow. A water sachet 301 is containing a plurality of sachets containing variable amounts of water to oxidize the powder sachets. A special box or sachet 302 is containing the oxidizing powder preferably Fe, Mg that in contact with water 303 induce an exchange exothermal reaction oxidizing and releasing hydrogen and water vapors 304 by boiling. The heat released is heating the food tray above 305 that are slightly tilted such as the water vapors condensing on the upper trays 305 to be recovered and reintroduced in the process.

The box may be designed for a variable number of meals and quantities. The standard design may be chosen for a squad or platoon having 18 or 30 servings per box. The boxes 305 contains the basic food a soup and a solid meal, while the third 306 contains a hot cake and drinks 307.

The hydrogen 304 released from the oxidizing reaction slightly depleted of the water vapors reaches a mixer with triangular interlaced shapes 308 that brings new oxygen from outside air 311 and combines with the hydrogen in the shaped catalytic felt 309 area designed for an anti-explosive operation. To have high efficiency the further exhausted gas containing nitrogen and water vapors is heating the upper trays 306 and 307 the water mainly condensing on that.

A heat exchanger 310 made from an aluminum foil separating the two ducts of intake air 311 and exhaust air 312 and further recovering heat and water the last drips being driven from the collector 316 into the Mg, Fe sachet tray 302. If the exhaust is having still enough moist content in northern Scandinavian or Alaska climate a Na or CaO filter may be added to retain the moisture and prevent the fog plume to appear.

The air intake 315, the exhaust gas 311 and the water sachet hole 313 for starting the water 303 flooding the sachet in the sachet compartment 302 may be unsealed from pealing off the label attached over and drawing cords with blades cuts and unseal both the reactive sachet or tray 302 and the water bag 301 starting the process.

It is possible that a pyrotechnic cord sealed in aluminum 317 to control the process unsealing the vents 313 and 315 and cut the box at the end of the process transforming it in a serving platform by paper engineering that over bends the facets and drags the trays. A supplementary incineration device may be used to turn the structure into a biodegradable ash.

Because the verticality is important a water bubble device 318 is showing the user the right position. Near the trays or above auxiliary eating instruments and condiments may be placed.

FIG. 3B shows another embodiment of the invention as application of the general structure in FIG. 1 by using the hot plate as individual or unit heater. The logistics philosophy is changed, compared to the FIG. 2A where a single use device was used for a single feed action, into a multiple use heater for various purposes.

The heater is composed from the heating plate 350 that feeds with a plurality of fuels 352 through the tube 353 oxidized by the fresh, warmed up air 354 by surrounding the heating box 351 and the exhausted gas 355. A filtering device holding the CO2 and water may be added together with a tube carrying away the exhaust as to minimize the IR signature. The food tray 356 is delivered as supply without any eating instruments that are for private use and not included in the box, the waste signature being minimized too.

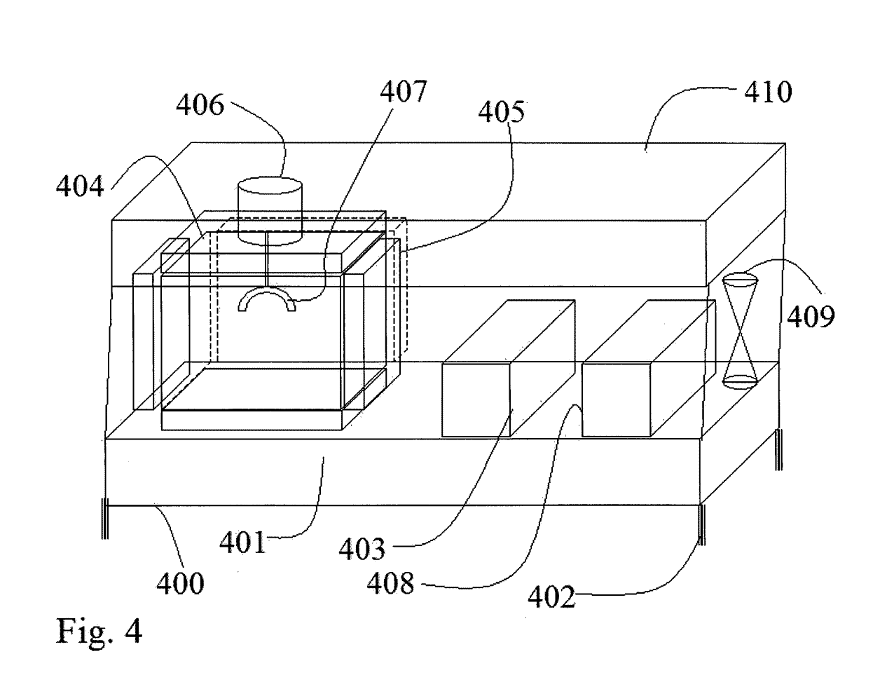

FIG. 4 shows another embodiment of the present invention related to the application of a plurality of catalytic heating plate from FIG. 3B as picnic/campain Food heater. The device is formed of a general use box possible of being configured in a plurality of hypostases working in regime of barbeque device as IR oven or thermostat for food.

The catalytic heating plates will have a set of holes through to be used for placing various exterior manual or electric actuator units. They will also have lateral hinges in order to be modularly configured.

The device 400 is a complete picnic set ready to deploy having a re-shapeable box for shipping purposes maintaining a sizeable cavity 403 warm and another cavity 408 cold during transportation and by a plurality of flexible heat-pipes 409 delivering heat or cold to other boxes. The box 401 transforms into an operational table by extracting legs 402 and taking out the boxes previously used for transportation purposes.

From the catalytic heating pads 405, deposited compact into the box 401 is shaped a barbeque oven 404 attaching an actuator 406 and a handling structure inside 407 also stored in the box may become a “kebab” cooker or some other type of kitchen robot or sophisticated on-site cooking device.

It may also hold pumps for water, drinkable water, normal, hot and cold, etc. bringing in nature the comfort of a luxurious restaurant being user and environment friendly by deodorizing using an exhaust catalytic filter with heat recovery in the upper box 410. The system 400 may be conceived as an upper trunk box having aerodynamic shape, or a usual rectangular technologic box.

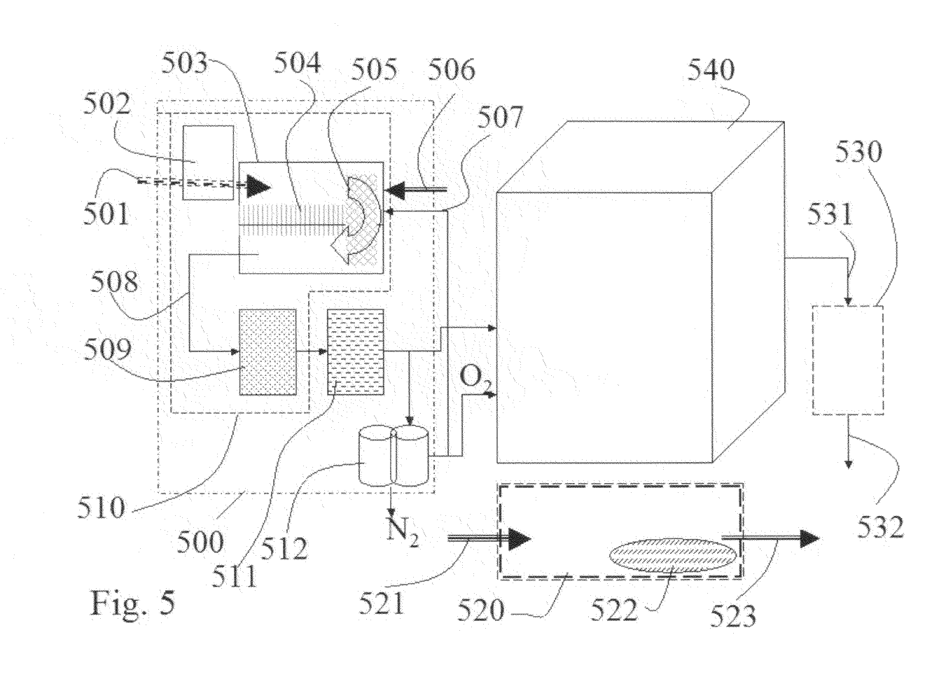

FIG. 5 shows another embodiment of the invention related to the application of the generalized catalytic structure in FIG. 1 as air catalytic cleaner for auto-vehicles odor and toxins removal system to habitable space oxygen level control. The present traffic conditions excels in carbon effluents as carbon dioxide, carbon monoxide, unburned fuel and other intermediary products vapors to which the nitrogen oxides, VOCs, etc from the industrial environment are added. To clean the air intake in the vehicle's habitable in a single step a catalytic air cleaner as described in the previous invention have to be used followed by a carbon dioxide removal system and a humidity and oxygen control system. Similar system may be applied for the engine exhaust and habitable and vehicle leaks.

The catalytic air cleaning system 500 is designed to clean the air aspirated in the vehicle cabin 540 and breathed by the passengers. The intake air 501 is filtered from dust and small particles and part of chemicals by a HEPA filter 502 and introduced in the catalytic deep cleaning device 503. The air is warmed up at the catalyst operating temperature by the heat exchanger 504 and electric assisting device 505 at the entry. The catalyst is also supplied with external heat by a heat-pipe 506 and extra fuel or reactive chemicals through the same entry 506. The oxygen is supplied by the specialized entry port 507 with control valves under processor control.

The hot reacted gas is cooled down by the heat exchanger 504 and the clean gas 508 flows into carbon dioxide retention unit 509 and a humidity control unit 511 being delivered into the cabin 540. It is possible that in various environments as forest fires, industrial areas, gas leaks the oxygen to be depleted in the catalytic cleaner 505 if no oxygen is added through the supply pipe 507 therefore a PSA (Pressure Swig Absorption) unit to be added to control the oxygen content in the cabin 540.

The basic system 510 may be used in a similar configuration 530 for cabin exhaust gas 531 cleanup so its delivery in environment 532 is odor free.

The same structure 510 sized in the enhanced drum unit 520 to be used for engine exhaust gas 521 to be further depleted of any pollutant and having the capability of collecting the carbon dioxide in a specialized tank 522 releasing only nitrogen and water in the final exhaust 523. These units applied to vehicles make them environment friendlier depleting the oxygen only.

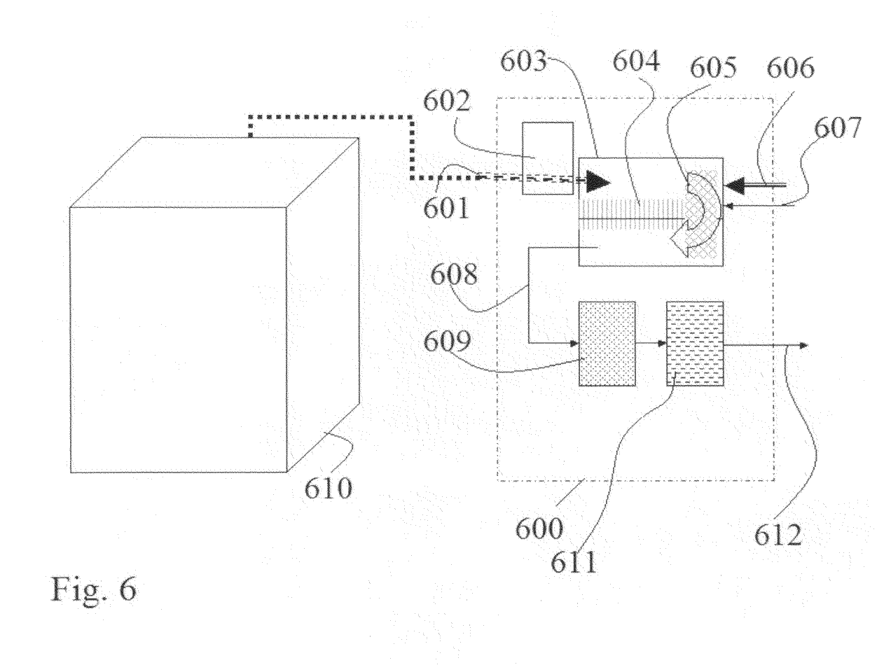

FIG. 6 shows Toilet and technologic rooms exhaust cleanup device as a simpler application from FIG. 4 because it misses the air composition conditioning devices.

The catalytic air cleaning system 600 is designed to clean the air exhausted by a technologic cabin 610 such a toilet, rest room, cooking oven using hydrocarbon based fuels or wood, other technologic areas producing toxic effluents. The intake air 601 is filtered from dust and small particles and part of chemicals by a HEPA filter 602 and introduced in the catalytic deep cleaning device 603. The air is warmed up at the catalyst operating temperature by the heat exchanger 604 and electric assisting device 605 at the entry. The catalyst is also supplied with external heat by a heat-pipe 606 and extra fuel or reactive chemicals through the same entry 606. The oxygen is supplied by the specialized entry port 607 with control valves under processor control.

The hot reacted gas is cooled down by the heat exchanger 604 and the clean gas 608 flows into the carbon dioxide retention unit 609 and a humidity control unit 611 being exhausted 612 or reintroduced in the cabin 610. It is possible that in various environments, industrial areas, gas leaks the oxygen to be depleted in the catalytic cleaner 605 if no oxygen is added through the supply pipe 607 therefore a PSA (Pressure Swig Absorption) unit to be added to control the oxygen content.

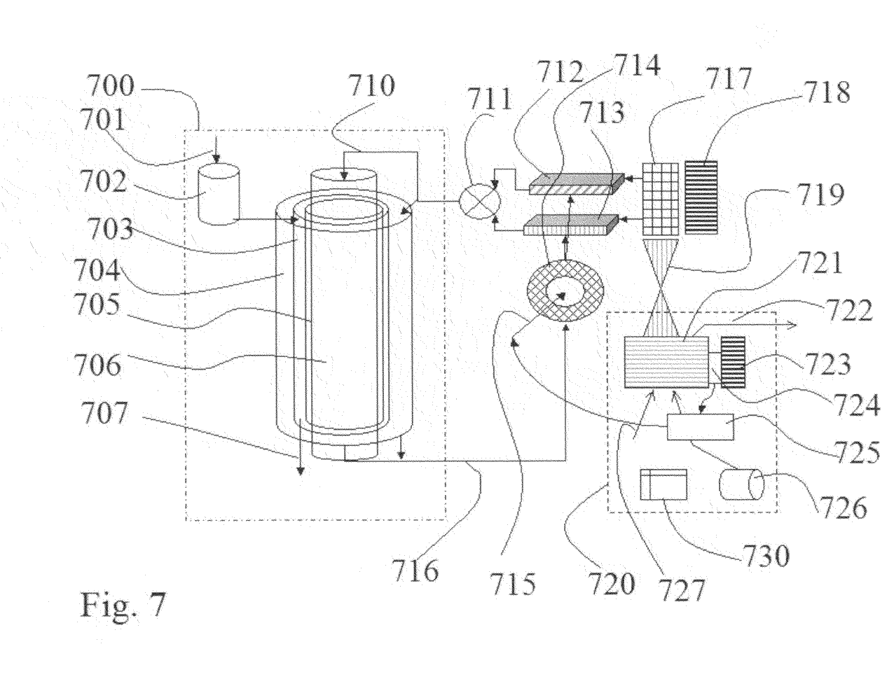

FIG. 7 is showing the application of the heating device for liquids heating by circulation as those for medical transfusion.

The properties of such a heater have to be uniform controlled temperature under the limit of liquid depreciation, such as the minimal residual volume in the heater to be as small as possible. If the liquid is blood the diameter of the system is limited by the blood viscosity and acceptable cell properties, the maximal flow and temperature gradient being limited. A double stage heat exchange system will be developed.

The blood and other liquids heating system 700 is based on the minimum amount required for being heated due to the limiting properties. The liquid comes from a reservoir through a tube 701 and enters into a flow temperature-regulating device 702 that pushes it into a narrow section duct 703 with rectangular or annular shape that maximizes the heat exchange surface with the heating agent. The heating agent is surrounding the liquid to be heated having the same shape flow tubes 704, 705 and flowing in a countercurrent to maximize the heat flow and to optimize the thermal exchange efficiency. The center of the pipe 706 may have liquid or is solid or empty having a small thermal capacity material. In the rectangular design the central tube 707 does not exist. The heated liquid exits though 707 and is send towards the infusion device. The heating fluid is entering the liquid-liquid exchanger by the inlet 710 splitting in two components inner and outer surrounding all the liquid to be heated and exiting by the tube 716. The two tubes allow a certain distance being insulated and allowing that the heating device to be placed in the best position. The liquid exchanger system is formed from an electric pump 714, supplied through the cord 715 from a buffer battery 725. The liquid enters through the tube 716 and is supplied to two heat exchangers one hot 712 and one cold 713 then a mixer 711 is adjusting the right temperature.

A heat source driving a cooling device by gaseous absorption procedure 717 is running the two thermal sources, releasing the exceeding heat into air through a thermopile and a heat sink 718. The heat is received from the catalytic heating module 720 through a flexible tube heat-pipe 719. This confers an extra distance and flexibility such as the placement in all terrain conditions and permitting the operation in cold and hot climate with thermal exhaust conceal. The heat module 720 is compact containing the catalytic heat source 721 fueled by a plurality of fuels from the tanks 726 and supplied with ambient air 727 filtered for dust particles. The exhaust 722 is driven through a tube at a certain distance and for small enclosures as aircraft or vehicles it may be equipped with a carbon-dioxide stopper and condenser module by a low temperature heat exchanger. The heat source 722 may also operate a supplementary electric power generator by a thermopile 724 and a heat sink 723 controlled separately. The device is conceived in such a way as to use various fuels and to prevent the contamination of the heated liquid by several heat exchangers having a short response time system and contamination monitoring. The microprocessor system 730 is controlling all the actuators and monitors and records the operation by a set of sensors and interlocks.

The usage of an intermediary liquid is to make the probability of contamination of the liquid to be heated smaller and to provide a mild and fast heating with minimal heat influences while the system is light and allows a long term silent operation. It may be applied also for industrial liquids or artic region or cold weather.

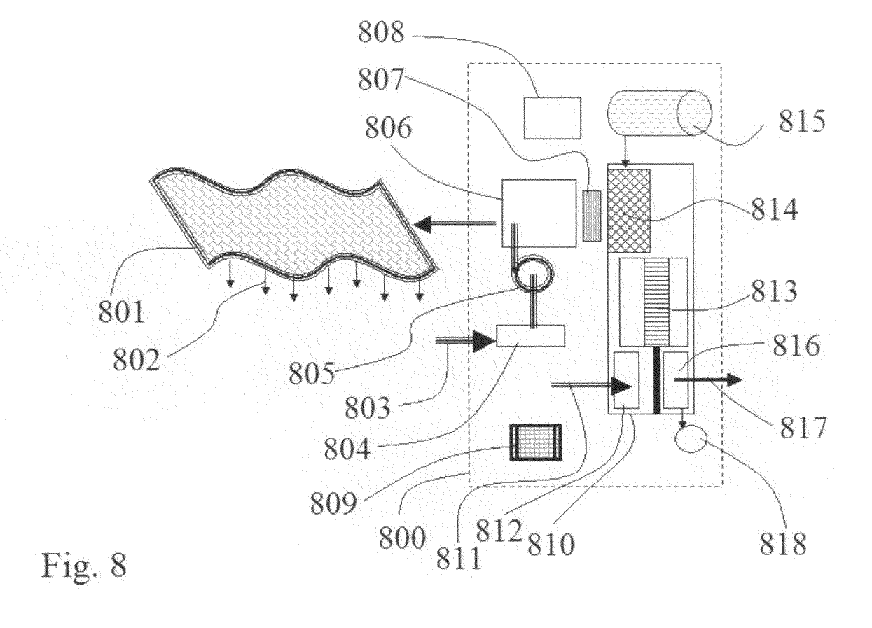

FIG. 8 presents another embodiment of the invention regarding a clean air cushion for industrial or medical application. Warm clothing and air heated blankets have a great importance for medical emergencies to prevent thermal shock of the wounded people if the system is designed to be light, portable and odor-less.

The portable heating unit 800 absorbs ambient air 803, filters it in a HEPA filter 804, and enters the aspiration of a turbine high flow pump 805 that pushes it out in a heat-exchanger unit 806 where it warms up to the desired temperature and is pushed out in the blanket or cloth part (coat, jacket, etc.) 801 from where it is released through a porous mesh fabric creating a warm, clean air cushion 802.

The heating unit 800 is composed of a catalytic unit 810 that aspirates air 811, filters for dust and liquid droplets 812 and warms up in a heat-exchanger 813 recovering the exhaust gas energy. The warmed-up gas is introduced in the catalytic burner 814 that may use a plurality of fuels 815, depending on catalyst type and regime. After burning the exhaust gas passes through the heat exchanger 813 into a carbon dioxide removal drum 816 and a condensed water drip collector 818. The cleaned exhaust gas is then released through a tube 817 such as to be placed outside the enclosures or far from being breathed or absorbed in the intake gas 803. The complete optimal burning is assured by a processor 809 powered from the electrical source 808 that includes a buffer battery and a adjusted power feeding system using the thermopile 807.

The system may deliver in any kind of equipment operating as gas spreader 801, being useful for fast technologic equipment defreezing in winter time or artic conditions.

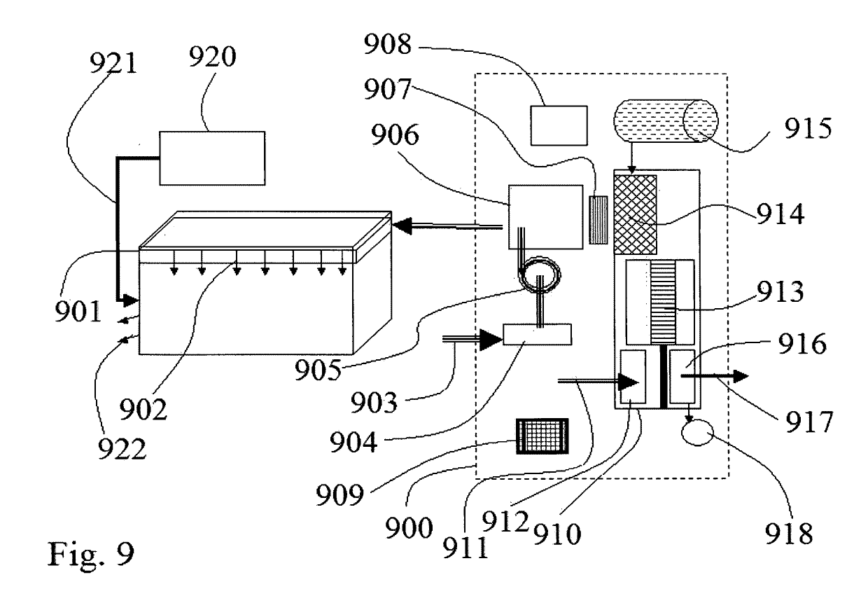

FIG. 9 shows another embodiment of the invention as application for a clean, climate controlled roo, tent, shelter in place, for medical application, emergency operator providing volume heating with sterilized air in white-room regime.

The clean conditioned air system is applied in a specialized roof of an emergency enclosure/tent made of HEPA filters with PM smaller than 0.3 microns. For cold climate the source is also heating while in hot or temperate systems the heating module must be replaced with a cooling system based on fluid-absorption (ammonia) and mixer delivering the right temperature.

The heating unit 900 is composed of a catalytic unit 910 that aspirates air 911, filters for dust and liquid droplets 912 and warms up in a heat-exchanger 913 recovering the exhaust gas energy. The warmed-up gas is introduced in the catalytic burner 914 that may use a plurality of fuels 915, depending on catalyst type and regime. After burning, the exhaust gas passes through the heat exchanger 913 into a carbon dioxide removal drum 916 and a condensed water drip collector 918. The cleaned exhaust gas is then released through a tube 917 such as to be placed outside the enclosures or far from being breathed or absorbed in the intake gas 903. The complete optimal burning is assured by a processor 909 powered from the electrical source 908 that includes a buffer battery and a adjusted power feeding system using the thermopile 907.

The emergency tent 901 has double walls kept pressurized with a similar equipment 920 delivering higher pressure 921 and having a slight porous release 922 towards outside to create a clean air cushion around the tent.

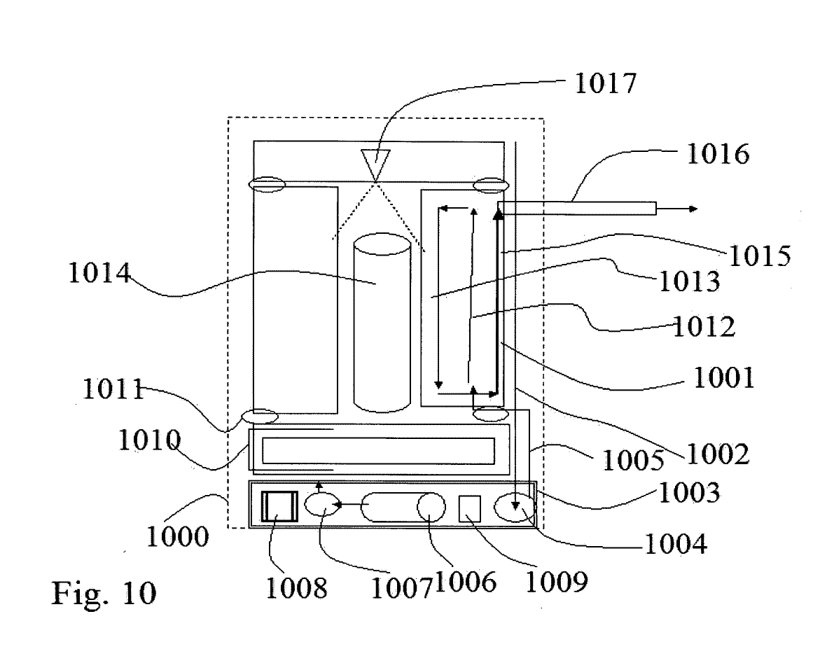

FIG. 10 shows another embodiment of the present invention referring to medical IR-UV sterilization base on low flammability system being similar with the personal heating unit but operating at higher temperature with water dripping from the top to create a highly vapor dense atmosphere to increase conduction and the antiseptic medium.

The heating unit 1000 is made from flat hot plates 1001 and insulator expandable plates 1010 up to six or more being combined such as to fulfill the usage desires, from heating at mild temperature up to hot regimes as those used in medical sterilization devices. The air intake 1002 is made on periphery and aspirated in a fan 1004 inside the utility pack 1003. The air exhaust 1005 is driven towards the center of the catalytic hot plate 1012 surrounding the fuel and reacting down to complete burning. The heat generated is transmitted by IR radiation, conduction and convection towards the center of the plate to a hard-coated aluminum surface facing the center of the box. The cooled burned gas is then passing the exterior surface giving the remnant heat to intake air via a heat exchanger 1015 and is evacuated through a duct 1016. The negative pressure on the borders makes that the box to be odor less and the potential gas leakage to be reabsorbed without contact to the inner surface.

The sealing hinges 1011 increase the insulation of the central box cavity. Inside the utility box 1003 there are a plurality of fuel tanks 1006 driving to specialized fuel pumps 1007 or manual pressurizing system and through a distribution system under the control of the processor 1008 is assuring the heaters optimal operation regime. An electric system 1009 formed from an electricity harvesting system and battery is powering the controller and actuators. The power variation is made by switching the number of catalytic cell in operation and by smooth continuous variation inside the catalyst operation domain.

The water, sterilizing material injector 1017 it is placed on the lid that also may hold multiple functions from sealing the box, to secondary deposit for accessories. In the center of the heating box is placed the content to be sterilized 1014 by heat exposure. The specific requirements determine the operation regime selected on process control system 1008.

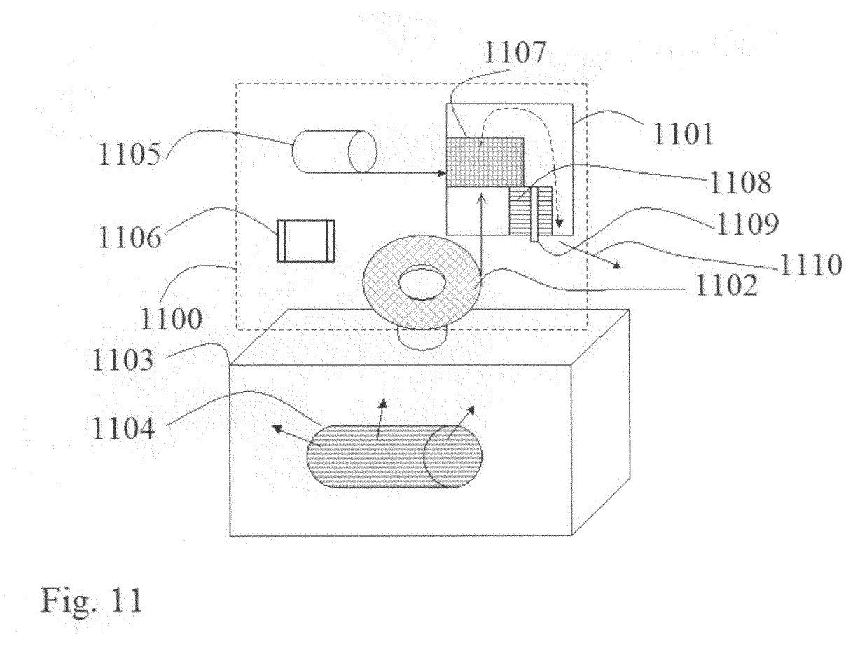

FIG. 11 Shows another embodiment of the present invention application for Hydrogen based devices leakage recovery and burnout, that may successfully work for any type of reactant effluent removal from gaseous atmospheres.

More with the development of the hydrogen industry based on fuel cells the release of hydrogen in the atmosphere will become an issue as important for the ozone depletion as was in the past the FCC that drive to the ban of freons in refrigeration systems. The system may be applied to other toxic or combustible gas leaking systems 1100.

It is composed from a catalytic combustible or toxic gas oxidizer system 1101 fed by a pump 1102 connected at a collection enclosure 1103 to the volume contaminated by the gas leaking object 1104. The pump's exhaust pushes the gas into the catalytic volume by preheating it in the heat exchanger 1108 recovering the heat from the exhaust gas. To maintain the optimal operation temperature the catalyst 1107 is supplied from a plurality of fuels 1105 and reactants to enhance the annihilation process. The exhausted gas is giving the heat to the intake gas through a thermo-pile 1109 loading a battery and feeding the electric actuators, fan 1102 and control system 1106. The control system is monitoring the contamination level inside the enclosure 1103 and the burning level in the exhaust 1110 of the catalytic oxidizer 1101. The start stop procedures are also controlled such as the requirements for compliance in any industrial explosive environment to be met.

Other applications not covered by Figures may be enumerated as examples of application of the invention are:

The military operations are:
Air cleaner deodorizer system is equivalent to the one presented in FIG. 2 and in the basic invention application, being composed from a catalytic filter able to burn bacteria and to oxidize and stabilize the chemicals and from a monitoring control system.
Vest heater for harsh climate with reduced IR and odor signature is the same as presented in FIG. 2 with gradual version for only heating, heating and body odor remover, zonal complex heating cooling to make the ambient of a gym room while in harsh environment, suit IR signature minimization by managing the external thermal emission, anti-bacterial and anti-chemical active protection by managing the gas exhaust of the suit, integration in shielding equipment and supplementary battlefield electronics.
Tent—shelter heater is similar to that presented in FIG. 9 but with small variations between cold, heat and mix versions as well for IR signature and camouflage development.
Vehicle start-up or ambient heater in cold climate is a multiple fuel heater similar to the IV solution meant to warm up the engine liquids or similar to a hot plate in FIG. 1 radiating heat on the sensitive parts and keeping them warm.
Absorption silent heater-cooler system is a general-purpose gas-absorption refrigeration system similar to ammonia-refrigerators powered by a catalytic heat source and developing efficiencies of 50% such as heat cold source is available at about ½ A power.
Thermo-electric power generator is a catalytic plate heating a thermopile and producing 4% of the thermal power as electric power. It is used for supplementary power needs of mobile equipment, being less productive than the fuel cell.
Liquids distillation as water purification, desalting in similar devices powering the heat source of a distillation column, based on heat recovery, such as the operation power is equivalent to the power lost by insulation and fluids residual heat.
Personal air purifier is the mobile solution presented in FIG. 2 attached on helmet and delivering fresh air, and conditioning the temperature inside. For increased camouflage other placements might be available.
Food heating with Hydrogen recovery is the meals ready to Eat box heat solution presented in FIG. 3A. The 3B solution also available for military usage.

Catalytic reactor/oxidizer may exhibit mal-operation regimes when used out of the good operation domain that is mitigated in the design in FIG. 1.

### Electrical Thermal Assistance is Required at the Beginning and the End of Operation

Because any combination of catalysts have a limited optimal operation domain the transition from rest to operation parameters have to be made odor-less and in the fasted way, minimizing any unpleasant effect. A combination of fuel start-up and electric solution can be developed by using a small electric starter, similar to a heat plug, a hydrogen warmup and radial propagarion, while removing the hydrogen from center to borders by the basic fuel in a radial fashion, while the stop is done by stopping the basic fuel, and applying hydrogen and electricity to leave the catalyst clean and dry.

### Catalytically Shutdowns Assisted by Exhaust Catalytic Burners that Complete the Burning

The concept is of a multiple stage shut-down by maintaining a continuous heat source similar to a safety flame, and facilitating the adjacent zones by a mild increase in temperature of the hot spot, and when the adjacent temperature reaches the minimal operating level switching it on fuel and its chimney to evacuation so a wave of stink less heat is propagating radial like a domino.

Catalyst Changing Device in Exhaust For devices where in transitory mode is hard to suppress the stink a better catalyst may be used only for assisting the transitory regimes cleaning the exhaust gases.

### SUMMARY OF FIG. 5 AND THEIR DESCRIPTIONS

FIG. 1. Main embodiment of the invention meant to assure the correct operation of a catalyst system
00—Main effluent entry processing
01—effluent
02—initial measurement unit
03—processor
04—correction
05—actuating unit
06—parametric measuring unit
07—new timed correction
08—corrective unit
09—effluent
10—corrections
11—catalytic reactor
12—positive pressure system
13—gas reactants input conditioner
14—flow intake pressure adjustment
15—product output parametric measurement system
16—dynamic parameter modification/heat exchanger
17—second stage
18—output flow
20—Catalytic reactor unit
40—Exhaust of the reacted effluents
41—output flow
42—correction system
43—measurement stage
44—resulted flow
45—final parametric adjustment
50—Process control unit

What is claimed is:

1. A catalytic reaction system made of
a plurality of input reactant feeding devices,
a catalytic reaction structure,
a control assembly comprising a plurality of sensors and actuators
a plurality of loops control systems,
application specific input and output systems as filters, heat exchangers,
case and accessories.

2. A catalytic reaction system according the claim 1 comprising a plurality of reactants parameters adjustment loops in the input system.

3. A catalytic reaction system according the claim 1 comprising a plurality of reactants parameters adjustment loops embedded in the catalyst.

4. A catalytic reaction system according the claim 1 comprising a plurality of catalyst stages stacked in the catalyst reaction zone.

5. A catalytic reaction system according the claim 1 comprising a plurality of exhaust parameters adjustment loops in the output system.

6. A catalytic reaction system according the claim 1 comprising a plurality of controllers for local adjustment loops interconnected to an assembly process controller.

7. A catalytic reaction system according the claim 1 comprising a plurality of temperature adjustment devices based on heat flow control.

8. A catalytic reaction system according to claim 1 comprising at least a control system to provide the right thermodynamic parameters to the catalyst in agreement with the reaction optimum by using a plurality of sensors, heat exchangers, fans and pumps.

9. A control system according to claim 7 based on predictive parameter adjustment made of a distributed micro-calculation units connected to sets of transducers and actuators.

10. A startup procedure based on zonal gradual entry in operation by using a combination of electric and alternate fuels heating and flow control.

11. A catalytic reaction device as recited in claim 1 comprising accumulators of electric and chemical power for self-sustainable operation.

12. A catalytic reaction system according the claim 1 being used to completely oxidize polluted air components to clean it.

13. A gas cleaning catalytic device as recited in claim 12 using a plurality of filters and heat exchangers to condition the exhaust gas.

14. A catalytic reaction system according the claim 1 used for protective suits.

15. A catalytic reaction system according the claim 1 comprising a plurality of heating modules for heating applications.

16. A catalytic reaction system according claim 1 comprising a plurality of catalytic layers and loop processes to cleanup the tail gas or smelter gas, by passing the through sequence of passive and active catalysts.

17. A catalytic reaction system according the claim 1 used in combination with air spreaders to produce a warm conditioned air cushion.

18. A catalytic reaction device according claim 1 using a plurality of reactants and catalysts used to remove the combustible toxic fraction in contaminated atmospheres.

19. A protective suit according the claim 14 comprising a plurality of temperature gas adjustment tiles embedded in the suit.

20. A catalytic reaction device, according claim 1 used as multi fuel emergency equipment delivering, heat, electricity, clean conditioned air and hot/cold source.
